(19) United States
(12) Patent Application Publication
(10) Pub. No.: US 2013/0327012 A1
(43) Pub. Date: Dec. 12, 2013

(54) GAS TURBINE ANTI-ICING SYSTEM

(71) Applicants: Mohammad Mahabub, Richmond, TX (US); Imran A. Khan, Spring, TX (US); Tho Vankhanh Nguyen, Cypress, TX (US)

(72) Inventors: Mohammad Mahabub, Richmond, TX (US); Imran A. Khan, Spring, TX (US); Tho Vankhanh Nguyen, Cypress, TX (US)

(73) Assignee: GENERAL ELECTRIC COMPANY, Schenectady, NY (US)

(21) Appl. No.: 13/493,989

(22) Filed: Jun. 11, 2012

(51) Int. Cl. F02C 7/047

(52) U.S. Cl. 60/39.093

(57) ABSTRACT

Embodiments of the present disclosure are directed towards a system having a compressor bleed air recirculation system. The compressor bleed air recirculation system includes a compressor bleed air line extending from a compressor to an air intake, wherein the compressor bleed air line is configured to flow a compressor bleed air flow, and the air intake is configured to supply an air flow to the compressor. The compressor bleed air recirculation system further includes an eductor disposed along the compressor bleed air line between the compressor and the air intake, wherein the eductor is configured to receive and mix the compressor bleed air flow and a first ambient air flow to form a first air mixture.

### BACKGROUND OF THE INVENTION

The subject matter disclosed herein relates to gas turbine systems, and, more particularly, to an anti-icing system for a gas turbine compressor.

Gas turbine systems generally include a compressor, a combustor, and a turbine. The compressor compresses air from an air intake, and subsequently directs the compressed air to the combustor. In the combustor, the compressed air received from the compressor is mixed with a fuel and is combusted to create combustion gases. The combustion gases are directed into the turbine. In the turbine, the combustion gases pass across turbine blades of the turbine, thereby driving the turbine blades, and a shaft to which the turbine blades are attached, into rotation. The rotation of the shaft may further drive a load, such as an electrical generator, that is coupled to the shaft.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a compressor bleed air recirculation system. The compressor bleed air recirculation system includes a compressor bleed air line extending from a compressor to an air intake, wherein the compressor bleed air line is configured to flow a compressor bleed air flow, and the air intake is configured to supply an air flow to the compressor. The compressor bleed air recirculation system further includes an eductor disposed along the compressor bleed air line between the compressor and the air intake, wherein the eductor is configured to receive and mix the compressor bleed air flow and a first ambient air flow to form a first air mixture.

In a second embodiment, a system includes a turbine, a combustor, a compressor having an air intake, wherein the air intake is configured to supply an air flow to the compressor, a first temperature sensor configured to measure a temperature of the air flow, and a compressor bleed air recirculation system. The compressor bleed air recirculation system includes a compressor bleed air line extending from the compressor to the air intake, and an eductor disposed along the compressor bleed air line between the compressor and the air intake, wherein the eductor is configured to receive and mix a compressor bleed air flow from the compressor and a first ambient air flow to form a first air mixture, and the eductor is configured to flow the first air mixture to the air intake.

In a third embodiment, a gas turbine system includes a compressor and an air intake configured to supply a first air flow to the compressor. The air intake includes a housing, an air filter configured to filter the first air flow, and a bleed air rake configured to receive a second air flow and flow the second air flow into the housing. The gas turbine system also includes a compressor bleed air recirculation system. The compressor bleed air recirculation system includes a compressor bleed air line extending from the compressor to the bleed air rake of the air intake, an eductor disposed along the bleed air line between the compressor and the bleed air rake, wherein the eductor is configured to receive a compressor bleed air flow from the compressor and a first ambient air flow to form the second air flow, and the eductor is configured to flow the second air flow to the bleed air rake, and a bleed valve disposed along the compressor bleed air line between the eductor and the compressor, wherein the bleed valve is configured to regulate a flow rate of the compressor bleed air flow.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic block diagram of an embodiment of a gas turbine system;

FIG. 2 is a schematic of an embodiment of a compressor bleed air recirculation system, which may be included in the gas turbine system of FIG. 1; and

FIG. 3 is a cross-sectional side view of an eductor, which may be included in the compressor bleed air recirculation system of FIG. 2.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include a compressor bleed air recirculation system for a gas turbine system. Specifically, in certain embodiments, the compressor bleed air recirculation system includes an anti-icing system configured to increase the temperature of air received by a compressor of the gas turbine system. For example, the compressor bleed air recirculation system may include an educator configured to mix compressor bleed air with ambient air, thereby reducing the temperature and pressure of the compressor bleed air. In other words, the compressor bleed air and ambient air mix within the eductor to form a first air mixture, which has a lower temperature and pressure than the compressor bleed air that enters the eductor. After the compressor bleed air is mixed with ambient air to form the first air mixture, the first air mixture may be directed towards a compressor bleed air rake within an air intake of the gas turbine system. In this manner, the first air mixture may mix with ambient air entering the air intake to form a second air mixture. The second air mixture formed within the air intake may have a temperature higher than the ambient air entering the air intake. In this manner, ice formation within the air filter housing may be reduced or substantially inhibited. Thereafter, the second air mixture formed within the air intake may be supplied to the compressor of the gas turbine system for compression.

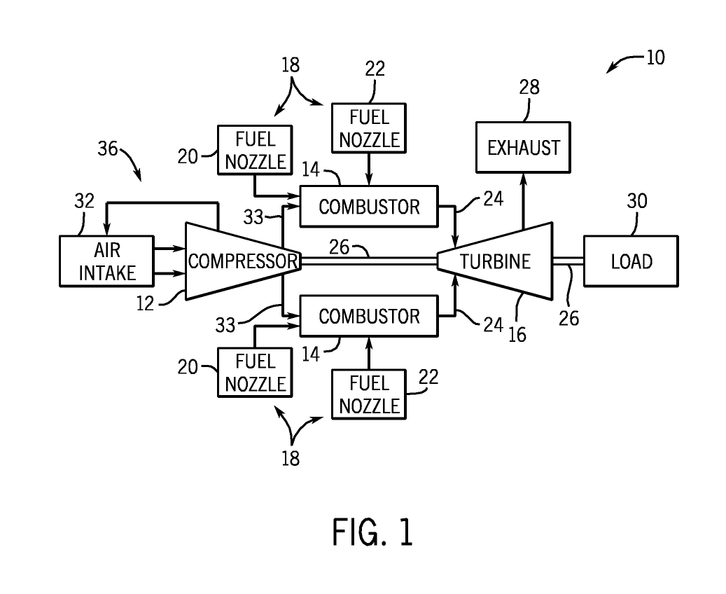

Turning now to the drawings, FIG. 1 illustrates a block diagram of an embodiment of a gas turbine system 10. The diagram includes a compressor 12, turbine combustors 14, and a turbine 16. The turbine combustors 14 include fuel nozzles 18 which route a liquid fuel and/or gas fuel, such as natural gas or syngas, into the turbine combustors 14. As shown, each turbine combustor 14 may have multiple fuel nozzles 18. More specifically, the turbine combustors 14 may each include a primary fuel injection system having primary fuel nozzles 20 and a secondary fuel injection system having secondary fuel nozzles 22.

The turbine combustors 14 ignite and combust an air-fuel mixture, and then pass hot pressurized combustion gasses 24 (e.g., exhaust) into the turbine 16. Turbine blades are coupled to a shaft 26, which is also coupled to several other components throughout the turbine system 10. As the combustion gases 24 pass through the turbine blades in the turbine 16, the turbine 16 is driven into rotation, which causes the shaft 26 to rotate. Eventually, the combustion gases 24 exit the turbine system 10 via an exhaust outlet 28. Further, the shaft 26 may be coupled to a load 30, which is powered via rotation of the shaft 26. For example, the load 30 may be any suitable device that may generate power via the rotational output of the turbine system 10, such as a power generation plant or an external mechanical load. For instance, the load 30 may include an electrical generator, a propeller of an airplane, and so forth.

In an embodiment of the gas turbine system 10, compressor blades are included as components of the compressor 12. The blades within the compressor 12 are coupled to the shaft 26, and will rotate as the shaft 26 is driven to rotate by the turbine 16, as described above. The rotation of the blades within the compressor 12 causes compression of air from an air intake 32, thereby creating pressurized air 33. The pressurized air 33 is then fed into the fuel nozzles 18 of the combustors 14. The fuel nozzles 18 mix the pressurized air 33 and fuel to produce a suitable mixture ratio for combustion (e.g., a combustion that causes the fuel to more completely burn) so as not to waste fuel or cause excess emissions.

As discussed in detail below, the gas turbine system 10 may also include a compressor bleed air recirculation system 36. For example, the compressor bleed air recirculation system 36 may be configured to direct compressor bleed air (e.g., pressurized air 34) from the compressor 12 to the air intake 32. More specifically, the recirculation system 36 may include an eductor configured to mix ambient air with the compressor bleed air flowing through the recirculation system 36, thereby creating a first air mixture and decreasing the temperature and pressure of the compressor bleed air flowing from the compressor 12 to the air intake 32. Thereafter, the recirculation system 36 may flow the compressor bleed air (e.g., the first air mixture) to the air intake 32, where the compressor bleed air (e.g., the first air mixture) may flow through a bleed air rake and mix with ambient air entering the air intake 32. As a result, the temperature of the ambient air entering the air intake 32 may be increased and a second air mixture may be formed with an elevated temperature. In this manner, ice formation within the air intake 32 may be blocked due to the elevated temperature.

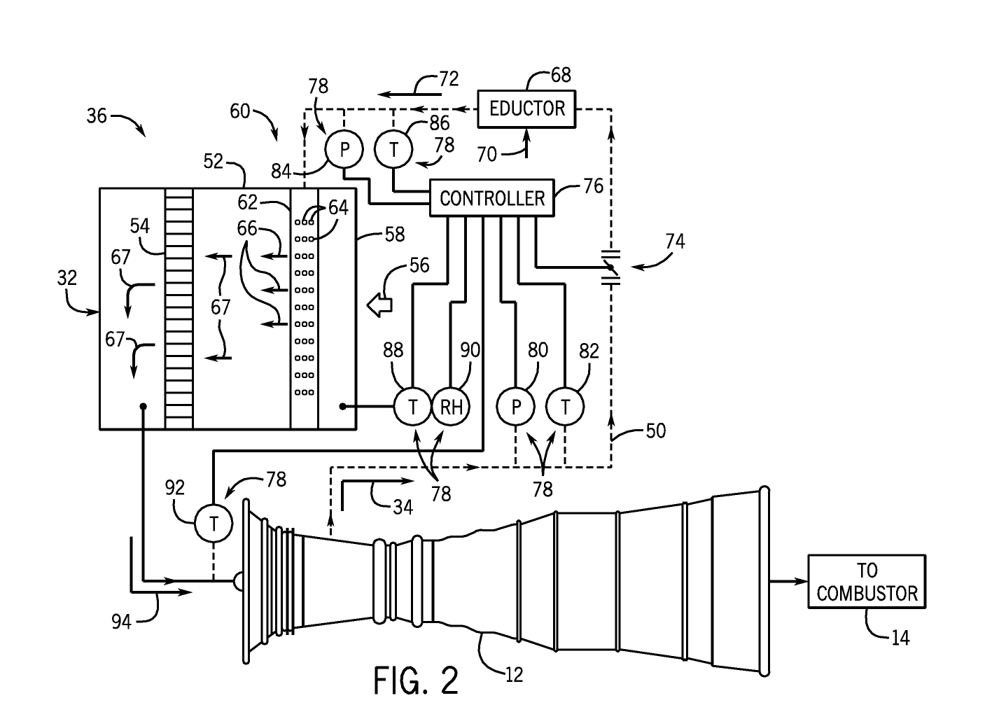

FIG. 2 is a schematic of an embodiment of the compressor bleed air recirculation system 36. As shown, the recirculation system 36 includes a compressor bleed air line 50 (e.g., a compressor bleed air conduit). In the illustrated embodiment, the compressor bleed air line 50 extends from the compressor 12 to the air intake 32. In this manner, the compressor bleed air line 50 directs pressurized air 34 from the compressor 12 to the air intake 32. However, in other embodiments, the compressor bleed air line 50 may flow to other components of the gas turbine system 10 or other systems external to the gas turbine system 10. As will be appreciated, the pressurized air 34 exiting the compressor 12 through the bleed air line 50 may have an elevated temperature and/or an elevated pressure. For example, in certain embodiments, the pressurized air 34 exiting the compressor 12 through the bleed air line 50 may be approximately 350 to 450° C. or more. Furthermore, the compressor bleed air (e.g., pressurized air 34) may exit the compressor 12 and flow into the compressor bleed air line 50 from different stages within the compressor 12. As will be appreciated, the pressurized air 34 may have different temperatures and/or pressures depending on the stage of the compressor 12 that the pressurized air 34 exits the compressor 12.

As mentioned above, the air intake 32 directs air to the compressor 12 for pressurization. In the illustrated embodiment, the air intake 32 includes a housing 52, which has an air filter 54. The air filter 54 is configured to remove debris, particles, and other foreign matter from ambient air 56, which enters the air intake 32 (e.g., the housing 52) through an inlet 58, before the air is directed to the compressor 12. When the ambient air 56 enters the air intake 32, the ambient air 56 may have a temperature between approximately −40 and 10° C. lower. Consequently, condensation from the ambient air 56 or other moisture within the air intake 32 may freeze to form ice within the air intake 32 (e.g., the housing 52) and downstream of the air intake 32 (e.g., at the compressor 12). For example, as the ambient air 56 passes through the air filter 54, water or moisture may separate from the ambient air 56 and subsequently freeze within the air intake 32.

To inhibit the formation of ice within the air intake 32, the compressor bleed air recirculation system 36 includes an anti-icing system 60. As shown, the anti-icing system 60 includes a bleed air rake 62 (e.g., a conduit) disposed within the housing 52 of the air intake 32. During operation, the bleed air rake 62 receives an air flow from the compressor bleed air line 50. After the air from the compressor bleed air line 50 enters the bleed air rake 62, the air may subsequently exit the bleed air rake 62 through apertures 64 formed in the bleed air rake 62. In other words, the air flowing through the bleed air rake 62 passes through the apertures 64 and enters the housing 52 of the air intake 32, as indicated by arrows 66. Within the housing 52 of the air intake 32, the air exiting the bleed air rake 62 may mix with the ambient air 56 entering the housing 52. The air mixture (referred to below as the second air mixture), represented by arrows 67, may then pass through the air filter 54 and flow to the compressor 12 for pressurization. While the illustrated embodiment includes one bleed air rake 62, other embodiments of the system 36 may include two or more bleed air rakes 62. For example, the bleed air rakes 62 may be disposed within the housing 52 in a parallel configuration, cross-wise configuration, and so forth. As mentioned above, the air flowing from the compressor 12 and through the compressor bleed air line 50 may have a high temperature. As a result, the ambient air 56 entering the housing 52 may increase in temperature as the air exiting the bleed air rake 62 (e.g., air 66) mixes with the ambient air 56. The temperature increase of the ambient air 56 may help reduce the formation of ice within the air intake 32.

As will be appreciated, certain embodiments of the bleed air rake 62 may be configured to receive an air flow below a certain temperature and/or pressure threshold. Consequently, the compressor bleed air flowing through the compressor bleed air line 50 (e.g., pressurized air 34) may be cooled before the air enters the bleed air rake 62 and the housing 52. For example, in the illustrated embodiment, the compressor bleed air recirculation system 36 includes an eductor 68. More specifically, the eductor 68 is disposed along the compressor bleed air line 50 between the compressor 12 and the air intake 32. As discussed in detail below, the eductor 68 is configured to mix the air flowing from the compressor 12 and through the compressor bleed air line 50 (e.g., pressurized air 34) with ambient air 70 to form a first air mixture. As the compressor bleed air (e.g., pressurized air 34) and ambient air 70 are mixed, the compressor bleed air may drop in temperature and pressure. In other words, the ambient air 70 enters the compressor bleed air line 50 through the eductor 68 and mixes with the compressor bleed air (e.g., pressurized air 34) flowing through the compressor bleed air line 50 from the compressor 12. In this manner, the temperature of the compressor bleed air (e.g., pressurized air 34), which may be approximately 350 to 450° C. or more when exiting the compressor 12, may be decreased (e.g., to a temperature suitable for flowing into the bleed air rake 62). That is, the first air mixture formed by the compressor bleed air and the ambient air 70 may have a lower temperature and/or lower pressure than the compressor bleed air that enters the eductor 68. Thereafter, the compressor bleed air (e.g., pressurized air 34) and ambient air 70 mixture (e.g., the first air mixture), represented by arrow 72, may flow through the compressor bleed air line 50 to the bleed air rake 62 within the housing 52 of the air intake 32.

The compressor bleed air recirculation system 36 further includes a valve 74 (e.g., a bleed valve) disposed along the compressor bleed air line 50. Specifically, the valve 74 is located along the compressor bleed air line 50 upstream of the eductor 68, i.e., between the eductor 68 and the compressor 12. As will be appreciated, the valve 74 may be configured to regulate flow of compressor bleed air (e.g., pressurized air 34) through the compressor bleed air line 50. For example, in certain embodiments, the valve 74 may have discrete open and closed positions, thereby allowing flow of compressor bleed air through the compressor bleed air line 50 or blocking flow of compressor bleed air through the compressor bleed air line 50. In other embodiments, the valve 74 may have variable positions, enabling the valve 74 to regulate various flow rates of the compressor bleed air (e.g., pressurized air 34).

Furthermore, the operation of the valve 74 may be regulated by a controller 76. For example, the controller 76 may regulate whether the valve 74 is in an open or closed position. Additionally, in some embodiments, the controller 76 may regulate the operation of the valve 74 based on feedback from various sensors 78 of the compressor bleed air recirculation system 36. For example, the system 36 includes a pressure sensor 80 and a temperature sensor 82 configured to measure a pressure and temperature, respectively, of the compressor bleed air (e.g., pressurized air 34) exiting the compressor 12 and flowing through the compressor air bleed line 50. Similarly, the system 36 includes a pressure sensor 84 and a temperature sensor 86 configured to measure a pressure and temperature, respectively, of the compressor bleed air and ambient air 70 mixture 72 (e.g., the first air mixture) exiting the eductor 68. In other words, the pressure sensor 84 and the temperature sensor 86 may measure a pressure and temperature, respectively of the first air mixture 72 entering the bleed air rake 62 within the housing 52 of the air intake 32.

Furthermore, the system 36 includes a temperature sensor 88 and a relative humidity sensor 90 configured to measure a temperature and a relative humidity, respectively, of the ambient air 56 entering the housing 52 of the air intake 32 through the inlet 58. Additionally, the system 36 includes a temperature sensor 92 configured to measure a temperature of air, represented by arrow 94, supplied to the compressor 12 from the air intake 32. As described below, feedback from the sensors 78 may be used by the controller 76 to regulate operation of the valve 74.

As mentioned above, the air (e.g., the first air mixture 72) entering the housing 52 through the bleed air rake 62 mixes with the ambient air 56 entering the housing 52 through the inlet 58. In this manner, the second air mixture 67 is formed, which may have a higher temperature than the ambient air 56. The temperature of the second air mixture 67 may be measured by the temperature sensor 92 as the second air mixture 67 flows from the air intake 32 to the compressor 12. In one embodiment of the system 36, the controller 76 may be configured to operate the valve 74 based, at least in part, on feedback from the temperature sensor 92. That is, the controller 76 may regulate operation of the valve 74, thereby regulating the flow of air (e.g., pressurized air 34) through the compressor bleed air line 50, to obtain a target temperature of the second air mixture 67 formed within the housing 52 of the air intake 32. In certain embodiments, the target temperature of the second air mixture 67 (e.g., measured by the temperature sensor 92) may be approximately 0 to 10, 2 to 8, or 4 to 6° C. greater than a temperature of the ambient air 56 measured by the temperature sensor 88. In other words, the system 36 may be configured to increase the temperature of the ambient air 56 by a desired amount when producing the second air mixture 67.

In one embodiment, when the temperature of the second air mixture 67 (e.g., air 94) measured by the temperature sensor 92 is below a target or desired temperature, the controller 76 may gradually or immediately open the valve 74. As a result, the flow rate of compressor bleed air through the compressor bleed air line 50 may increase, thereby increasing the flow of compressor bleed air through the eductor 68. As the flow of compressor bleed air (e.g., pressurized air 34) into the eductor 68 increases, the amount of ambient air 70 flowing into the eductor 68 may increase, as discussed below. Therefore, the flow rate of the first air mixture 72 formed within of the eductor 68 may increase, and the bleed air rake 62 may flow more of the first air mixture 72 into the housing 52. The increase in the amount of the first air mixture 72 flowing into the housing 52 may cause an increase in the temperature of the second air mixture 67 formed in the housing 52. Conversely, if the temperature of the second air mixture 67 (e.g., air 94) measured by the temperature sensor 92 is above a desired or target temperature, the controller 76 may gradually or immediately close the valve 74. As a result, the flow rate of compressor bleed air through the compressor bleed air line 50 may decrease, thereby decreasing the flow of compressor bleed air through the eductor 68. As the flow of compressor bleed air (e.g., pressurized air 34) into the eductor 68 decreases, the amount of ambient air 70 flowing into the eductor 70 may also decrease, as discussed below. Therefore, the flow rate of the first air mixture 72 formed within of the eductor 68 may decrease, and the bleed air rake 62 may flow less of the first air mixture 72 into the housing 52. The decrease in the amount of the first air mixture 72 flowing into the housing 52 may cause a decrease in the temperature of the second air mixture 67 formed in the housing 52.

Furthermore, while the embodiments described above include the use of feedback from the temperature sensor 92 by the controller 76, other embodiments of the controller 76 may use feedback from other sensors 78 and/or additional sensors 78 in the system 36. For example, the controller 76 may utilize feedback from the temperature sensors 82, 86, and/or 88, the pressure sensors 80 and/or 84, and/or the relative humidity sensor 90 in regulating the operation of the valve 74. As will be appreciated, the feedback from the other various sensors 78 in the system 36 may be used by the system 36 to help produce the first air mixture 72 and/or the second air mixture 67 at desired temperatures and/or pressures.

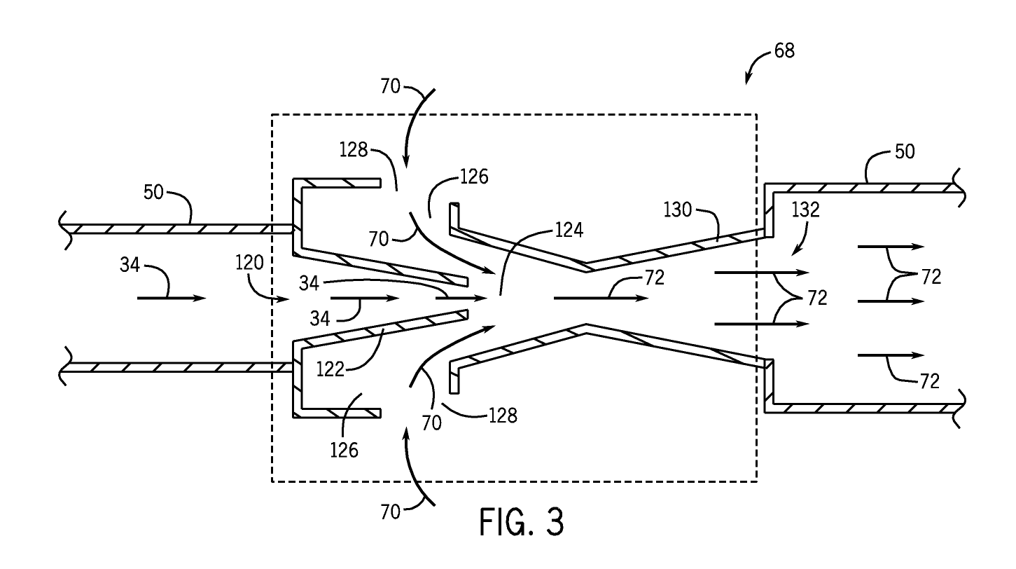

FIG. 3 is a cross-sectional side view of an embodiment of the eductor 68, which may be included in the compressor bleed air recirculation system 36. More specifically, the eductor 68 is configured to receive a flow of the compressor bleed air (e.g., pressurized air 34) flowing through the compressor bleed air line 50 and mix the compressor bleed air (e.g., pressurized air 34) with ambient air 70. As shown, the compressor bleed air (e.g., pressurized air 34) enters the eductor 68 through an inlet 120 and flows through a nozzle portion 122 (e.g., a converging conduit or section) of the eductor 68. As the compressor bleed air (e.g., pressurized air 34) flows through the nozzle portion 122, the velocity of the compressor bleed air (e.g., pressurized air 34) increases and a low pressure area 124 forms at an exit of the nozzle portion 122. The low pressure area 124 creates a suction force within an annular passage 126 of the eductor 68. As shown, the annular passage 126 is formed about the nozzle portion 122 and includes an inlet 128 through which the ambient air 70 may flow. The suction force within the annular passage 126 created by the low pressure area 124 draws ambient air 70 into the annular passage 126 through the inlet 128. The ambient air 70 flows into the annular passage 126 and, subsequently, flows into the low pressure area 124 where the ambient air 70 mixes with the compressor bleed air (e.g., pressurized air 34) to form the first air mixture 72. Thereafter, the first air mixture 72 continues through a diffuser portion 130 (e.g., a diverging conduit or section) of the eductor 68 and flows from the eductor 68 into the compressor bleed air line 50 through an outlet 132. As will be appreciated, the eductor 68 may operate without a motor, fan, or other powered mechanical device, which may help reduce the cost and/or complexity of the system 36. Additionally, while the illustrated embodiment of the eductor 68 includes an annular passage 126 configured to receive the ambient air 70, other embodiments of the eductor 68 may have other configurations or passages to receive the ambient air 70.

As mentioned above, when the ambient air 70 flows into the eductor 68, the ambient air 70 decreases the temperature and/or pressure of the compressor bleed air (e.g., pressurized air 34) to form the first air mixture 72. Consequently, the first air mixture 72 may also have a lower temperature and/or pressure than the compressor bleed air (e.g., pressurized air 34) that enters the eductor 68. In certain embodiments, the decreased temperature and/or pressure of the first air mixture 72 may enable the use of various bleed air rakes 62 within the air intake 32 that have upper temperature and/or pressure thresholds and/or low temperature and/or pressure configurations. As will be appreciated, bleed air rakes 62 with low pressure and/or low temperature designs may be cheaper, simpler in design, and may generate less noise pollution than other bleed air rakes 62.

As discussed in detail above, the disclosed embodiments include the compressor bleed air recirculation system 36 for the gas turbine system 10. Specifically, the compressor bleed air recirculation system 36 includes the anti-icing system 60, which is configured to increase the temperature of air (e.g., the second air mixture 67) supplied to the compressor 12 of the gas turbine system 10. For example, the compressor bleed air recirculation system 36 may include the eductor 68 configured to mix compressor bleed air (e.g., pressurized air 34) with ambient air 70, thereby reducing the temperature and pressure of the compressor bleed air (e.g., pressurized air 34) to form the first air mixture 72. After the compressor bleed air (e.g., pressurized air 34) is mixed with the ambient air 70, the compressor bleed air and ambient air mixture (e.g., the first air mixture 72) is directed towards the compressor bleed air rake 62 within the housing 52 of the air intake 32 of the gas turbine system 10. In this manner, the first air mixture 72 may mix with ambient air 56 entering the inlet 58 of the housing 52 to form the second air mixture 67. The temperature of the second air mixture 67 may be greater than the temperature of the ambient air 56 entering the housing 52 of the air intake 32, thereby reducing or blocking ice formation within the housing 52 of the air intake 32. Thereafter, the second air mixture 67 (e.g., air 94) may be supplied to the compressor 12 of the gas turbine system 10 for compression.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a compressor bleed air recirculation system, comprising:
a compressor bleed air line extending from a compressor to an air intake, wherein the compressor bleed air line is configured to flow a compressor bleed air flow, and the air intake is configured to supply an air flow to the compressor; and
an eductor disposed along the compressor bleed air line between the compressor and the air intake, wherein the eductor is configured to receive and mix the compressor bleed air flow and a first ambient air flow to form a first air mixture.

2. The system of claim 1, wherein the air intake comprises a bleed air rake, and the bleed air rake is configured to receive the first air mixture from the compressor bleed air line.

3. The system of claim 2, wherein the bleed air rake comprises a conduit with apertures, and the apertures are configured to flow the first air mixture into the air intake.

4. The system of claim 3, wherein the air intake comprises an inlet configured to receive a second ambient air flow, and the air intake is configured to mix the first air mixture and the second ambient air flow to form a second air mixture.

5. The system of claim 4, wherein the air intake is configured to supply the second air mixture to the compressor.

6. The system of claim 1, comprising a bleed valve disposed along the compressor bleed air line between the compressor and the eductor.

7. The system of claim 6, wherein the bleed valve is configured to regulate a flow rate of the compressor bleed air flow through the compressor bleed air line, and the bleed valve is configured to be operated by a controller.

8. The system of claim 7, comprising the controller configured to operate the bleed valve based on feedback from at least one sensor of the compressor bleed air recirculation system.

9. The system of claim 8, wherein the at least one sensor comprises a first temperature sensor configured to measure a first temperature of the compressor bleed air flow, a first pressure sensor configured to measure a first pressure of the compressor bleed air flow, a second temperature sensor configured to measure a second temperature of the first air mixture, a second pressure sensor configured to measure a second pressure of the first air mixture, or a third temperature sensor configured to measure a third temperature of the air flow supplied to the compressor by the air intake.

10. The system of claim 1, comprising a gas turbine system having the compressor bleed air recirculation system, the compressor, a combustor, and a turbine.

11. The system of claim 1, wherein the air intake comprises a housing and a filter configured to filter air flow supplied to the compressor.

12. A system, comprising:
a gas turbine system, comprising:
a turbine;
a combustor;
a compressor having an air intake, wherein the air intake is configured to supply an air flow to the compressor;
a first temperature sensor configured to measure a temperature of the air flow; and
a compressor bleed air recirculation system, comprising:
a compressor bleed air line extending from the compressor to the air intake;
an eductor disposed along the compressor bleed air line between the compressor and the air intake, wherein the eductor is configured to receive and mix a compressor bleed air flow from the compressor and a first ambient air flow to form a first air mixture, and the eductor is configured to flow the first air mixture to the air intake.

13. The system of claim 12, wherein the air intake comprises a housing, and the housing includes an air filter and a bleed air rake configured to receive the first air mixture and flow the first air mixture into the housing.

14. The system of claim 13, wherein the housing is configured to receive a second ambient air flow and mix the second ambient air flow with the first air mixture to form the air flow supplied to the compressor.

15. The system of claim 14, wherein the compressor bleed air recirculation system comprises a bleed valve disposed along the compressor bleed air line between the eductor and the compressor, and the bleed valve is configured to regulate a flow rate of the compressor bleed air flow.

16. The system of claim 15, comprising a controller configured to regulate the operation of the bleed valve based on feedback from the first temperature sensor.

17. A gas turbine system, comprising:
a compressor;
an air intake configured to supply a first air flow to the compressor, the air intake comprising:
a housing;
an air filter configured to filter the first air flow; and
a bleed air rake configured to receive a second air flow and flow the second air flow into the housing; and
a compressor bleed air recirculation system, comprising:
a compressor bleed air line extending from the compressor to the bleed air rake of the air intake;
an eductor disposed along the bleed air line between the compressor and the bleed air rake, wherein the eductor is configured to receive a compressor bleed air flow from the compressor and a first ambient air flow to form the second air flow, and the eductor is configured to flow the second air flow to the bleed air rake; and
a bleed valve disposed along the compressor bleed air line between the eductor and the compressor, wherein the bleed valve is configured to regulate a flow rate of the compressor bleed air flow.

18. The system of claim 17, wherein the housing of the air intake is configured to receive a second ambient air flow, and the housing of the air intake is configured to mix the second ambient air flow and the second air flow to form the first air flow.

19. The system of claim 18, wherein the compressor bleed air recirculation system comprises a plurality of sensors, wherein the plurality of sensors comprises a first temperature sensor configured to measure a first temperature of the first air flow, a second temperature sensor configured to measure a second temperature of the compressor bleed air flow, a third temperature sensor configured to measure a third temperature of the second air flow, a fourth temperature sensor configured to measure a fourth temperature of the second ambient air flow, a first pressure sensor configured to measure a first pressure of the compressor bleed air flow, a second pressure sensor configured to measure a second pressure of the second air flow, a relative humidity sensor configured to measure a first relative humidity of the second ambient air flow, or a combination thereof.

20. The system of claim 19, wherein the compressor bleed air recirculation system comprises a controller configured to operate the bleed air valve based on feedback from at least one of the plurality of sensors.
